(19) United States
(12) Patent Application Publication
(10) Pub. No.: US 2008/0314963 A1
(43) Pub. Date: Dec. 25, 2008

(54) Bonding Tool With Improved Finish

(75) Inventors: Harel Itzhaky, Kiryat Tivon (IL); Giyora Gur, Ramat Ishay (IL); Benjamin Sonnenreich, Haifa (IL); Ziv Atzmon, Zihron Yackov (IL)

Correspondence Address: KULICKE AND SOFFA INDUSTRIES, INC., 1005 VIRGINIA DRIVE, FORT WASHINGTON, PA, 19034, US

(73) Assignee: KULICKE AND SOFFA INDUSTRIES, INC., Fort Washington, PA (US)

(21) Appl. No.: 12/093,688

(22) PCT Filed: Jun. 19, 2007
(86) PCT No.: PCT/US2007/071595

§ 371 Date: May 14, 2008

Related U.S. Application Data
(60) Provisional application No. 60/806,503, filed on Jul. 3, 2006.
(60) Provisional application No. 60/884,920, filed on Jan. 15, 2007.

(51) Int. Cl. B23K 37/00

(52) U.S. Cl. 228/4.5

(57) ABSTRACT

A bonding tool includes a body portion terminating at a tip portion. The tip portion is formed from a material, wherein a grain structure of the material is exposed for at least a portion of the tip portion.

### CROSS-REFERENCE TO RELATED APPLICATIONS

This application claims the benefit of U.S. Provisional Application No. 60/806,503, filed Jul. 3, 2006, and of U.S. Provisional Application No. 60/884,920, filed Jan. 15, 2007, the contents of both of which are incorporated herein by reference.

### FIELD OF THE INVENTION

The present invention relates to the bonding tools used in the formation of wire loops, and more particularly, to bonding tools having an improved finish.

### BACKGROUND OF THE INVENTION

In the processing and packaging of semiconductor devices, wire bonding continues to be the primary method of providing electrical interconnection between two locations within a package (e.g., between a die pad of a semiconductor die and a lead of a leadframe). To form wire loops to provide this interconnection, bonding tools (e.g., capillary tools, wedge bonding tools, etc.) are typically used.

Conventional bonding tools typically have a polished surface. This polished surface includes the tip portion of the bonding tool. Certain bonding tool manufacturers also offer a “matte” finish bonding tool, where the matte finish is a roughened surface.

In the wire bonding industry there is continuous pressure for developments which provide improved results such as increased wire bond strength (e.g., first bond strength, second bond strength, etc.), reduced assist rates for the bonding operation, reduced variability among wire loops, etc.

Thus, it would be desirable to provide improved bonding tools to provide improved wire bonding operation results.

### SUMMARY OF THE INVENTION

According to an exemplary embodiment of the present invention, a bonding tool including a body portion terminating at a tip portion is provided. The tip portion is formed from a material, wherein a grain structure of the material is exposed for at least a portion of the tip portion.

According to another exemplary embodiment of the present invention, a bonding tool including a body portion terminating at a tip portion is provided. A surface of at least a portion of the tip portion defines a plurality of asperities, wherein a density of the asperities is at least 15 micronŝ−2, and wherein a surface roughness average at the portion of the tip portion defining the plurality of asperities is at least 0.03 microns.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1A is a side sectional view of a bonding tool that may be provided with an improved surface in accordance with an exemplary embodiment of the present invention;

FIG. 1B is a detailed view of a portion of the bonding tool of FIG. 1A;

FIG. 2A is a side sectional view of another bonding tool that may be provided with an improved surface in accordance with an exemplary embodiment of the present invention;

FIG. 2B is a detailed view of a portion of the bonding tool of FIG. 2A;

FIG. 2C is a perspective view of a portion of the bonding tool of FIG. 2A;

FIG. 3 is a perspective view of a tip portion of a bonding tool in accordance with an exemplary embodiment of the present invention;

FIG. 4A is a detailed view of a portion of a tip portion of a bonding tool in accordance with an exemplary embodiment of the present invention;

FIG. 4B is a detailed view of a portion of a tip portion of a bonding tool in accordance with another exemplary embodiment of the present invention;

FIG. 4C is a detailed view of a portion of a tip portion of a bonding tool in accordance with yet another exemplary embodiment of the present invention;

FIG. 5 is a diagram of a contact model of rough surfaces useful for understanding exemplary bonding tool surfaces in accordance with the present invention;

FIG. 6A is a perspective view photograph of a tip portion of a bonding tool in accordance with an exemplary embodiment of the present invention;

FIG. 6B is a detailed view of a portion of FIG. 6A;

FIG. 7A is a perspective view photograph of a tip portion of a bonding tool in accordance with another exemplary embodiment of the present invention;

FIG. 7B is a detailed view of a portion of FIG. 7A;

FIG. 7C is another detailed view of a portion of FIG. 7A;

FIG. 8A is a photograph of a second bond of a wire loop formed using a bonding tool in accordance with an exemplary embodiment of the present invention;

FIG. 8B is a photograph of a first bond of a wire loop formed using a bonding tool in accordance with an exemplary embodiment of the present invention;

FIG. 9A is a graph comparing stitch pull test results for a conventional bonding tool and a bonding tool in accordance with an exemplary embodiment of the present invention;

FIG. 9B is a chart of the data in the graph of FIG. 9A;

FIG. 10A is a photograph of a second bond of a wire loop formed in accordance with an exemplary embodiment of the present invention;

FIG. 10B is a detailed view of a portion of FIG. 10A;

FIG. 11A is a perspective view photograph of a tip portion of a bonding tool in accordance with an exemplary embodiment of the present invention;

FIG. 11B is a perspective view photograph of a tip portion of another bonding tool in accordance with another exemplary embodiment of the present invention;

FIG. 12A is a graph comparing Cpk of stitch pull test results for a conventional bonding tool and two bonding tools in accordance with exemplary embodiments of the present invention;

FIG. 12B is a chart of the data in the graph of FIG. 12A;

FIG. 13A is a photograph of a portion of a tip portion of a bonding tool in accordance with an exemplary embodiment of the present invention;

FIG. 13B is a photograph of a portion of a tip portion of another bonding tool in accordance with another exemplary embodiment of the present invention;

FIG. 13C is a graph comparing stitch pull test results for a conventional polished bonding tool and two bonding tools in accordance with exemplary embodiments of the present invention;

FIG. 14A is a table including data comparing the life of bonding tools in accordance with exemplary embodiments of the present invention and conventional bonding tools;

FIG. 14B is a bar chart of the data in FIG. 14A;

FIG. 15A is a photograph of a second bond of a wire loop formed using a bonding tool in accordance with an exemplary embodiment of the present invention;

FIG. 15B is a photograph of a portion of a surface of a bonding tool used to form the second bond of FIG. 15A;

FIG. 15C is a photograph of a second bond of a wire loop formed using a conventional matte finish bonding tool;

FIG. 15D is a photograph of a portion of a surface of a bonding tool used to form the second bond of FIG. 15C;

FIG. 15E is a photograph of a second bond of a wire loop formed using a conventional polished bonding tool;

FIG. 15F is a photograph of a portion of a surface of a bonding tool used to form the second bond of FIG. 15E;

FIG. 16A is a table including data related to the pull strength of second bonds of wire loops formed using a bonding tool in accordance with an exemplary embodiment of the present invention; and

FIG. 16B is a table including data related to the pull strength of second bonds of wire loops formed using conventional bonding tools.

### DETAILED DESCRIPTION OF THE INVENTION

The present application will refer to terms known in the art including for example, surface roughness, asperities, density of asperities, and the like. Such expressions are known in the art, for example, in the following publications, each of which is incorporated by reference in its entirety: (1) Greenwood, J. A. & Williamson, J. B. P., Contact of Nominally Flat Surfaces, Proc. Roy. Soc. (London), Series A295, pp. 300-319, 1966; (2) Kogut, Lior & Etsion, Izhak, A Static Friction Model for Elastic-Plastic Contacting Rough Surfaces, Journal of Tribology (ASME), Vol. 126, pp. 34-40, January 2004; and (3) Kogut, L. & Etsion, I., An Improved Elastic-Plastic Model for the Contact of Rough Surfaces, 3^{rd} AIMETA International Tribology Conference, Salermo, Italy, Sep. 18-20, 2002.

As is known to those skilled in the art, a surface (e.g., a surface of a bonding tool such as a capillary) may be characterized by independent parameters such as: (1) Rₐ—Surface roughness average; (2) σ—Standard deviation of asperity heights; and (3) R—Asperity radius of curvature. Further, other useful parameters include, for example: (4) η—Areal density of asperities and (5) β=ηRσ.

As is known to those skilled in the art, surface roughness average (Rₐ) is the area between the roughness profile and its mean line, or the integral of the absolute value of the roughness profile height over the evaluation length. Where L is the evaluation length, r is the height, and x is the distance along the measurement, Rₐ may be characterized by the following expression:

$${R}_{a} = \frac{1}{L} {\int }_{0}^{L} \vert r ( x ) \vert d x$$

According to an exemplary embodiment of the present invention, a bonding tool tip surface was provided having the following characteristics.

| η | R | σ | Ra |
|---|---|---|---|
| [micron\hat{ }²] | [micron] | [micron] | [micron] |
| 23.841 | 0.185 | 0.055 | 0.047 |

Such a bonding tool provided excellent pull strength (e.g., at 2^{nd} bond), a long life tool, and a tool with a relatively high MTBA.

According to an exemplary embodiment of the present invention, an Ra value of at least 0.03 microns along with η being at least 15 micrô⁻² (i.e., 15 per square micron) provided excellent results. In another example, an Ra value of at least 0.03 microns along with η being at least 20 micron̂⁻² also provided excellent results. Further, an Ra value of at least 0.04 microns combined with η being at least 20 micron̂⁻² provided outstanding results. Surface profile measurements of a bonding tool may be made using a number of techniques, for example, using an atomic force microscopy (i.e., AFM) machine.

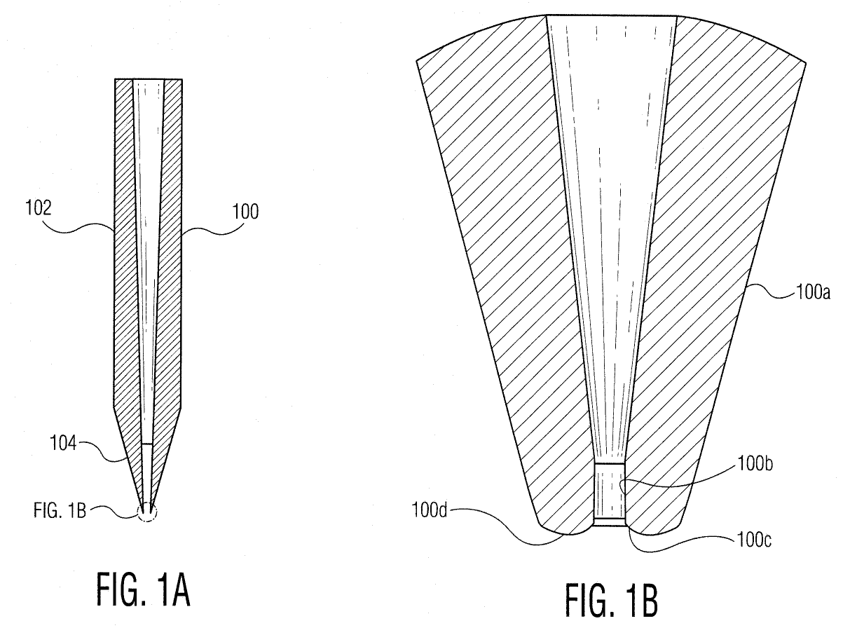

FIG. 1A is a side sectional view of bonding tool 100 that may be provided with an improved surface in accordance with an exemplary embodiment of the present invention. Bonding tool 100 includes shaft portion 102 and conical portion 104, where shaft portion 102 and conical portion 104 may be collectively referred to as the body portion of bonding tool 100. As is known to those skilled in the art, the terminal end of shaft portion 102 (i.e., the end of shaft portion 102 at the top of the image in FIG. 1A) is configured to be engaged in a transducer (e.g., an ultrasonic transducer) of a wire bonding machine. The terminal end of conical portion 104 (i.e., the end of conical portion 104 at the bottom of the image in FIG. 1A) is configured to form wire bonds at bonding locations (e.g., die pads of a semiconductor die, leads of a leadframe/substrate, etc.). FIG. 1B is a detailed view of the terminal end of conical portion 104. More specifically, tip portion 100a of bonding tool 100 is shown in FIG. 1B. Tip portion 100a defines hole 100b, inner chamfer 100c, and face portion 100d, amongst other features. As will be explained in greater detail below, bonding tool 100 is an example of a bonding tool which may be provided with an improved surface in accordance with the present invention.

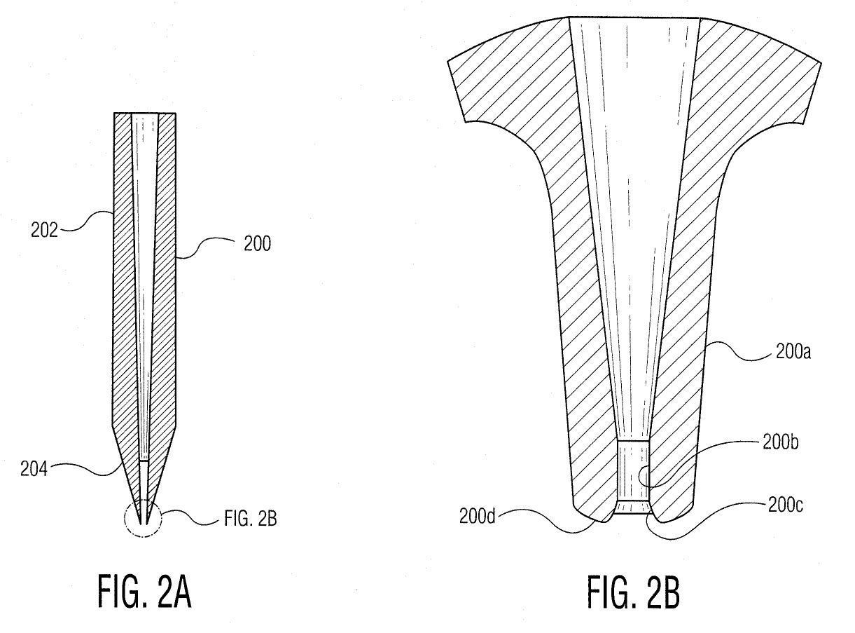

FIG. 2A is a side sectional view of bonding tool 200 that may be provided with an improved surface in accordance with an exemplary embodiment of the present invention. Bonding tool 200 includes shaft portion 202 and conical portion 204 (collectively the body portion). FIG. 2B is a detailed view of the terminal end of conical portion 204. More specifically, tip portion 200a of bonding tool 200 is shown in FIG. 2B. Tip portion 200a defines hole 200b, inner chamfer 200c, and face portion 200d, amongst other features. FIG. 2C is a perspective view of tip portion 200a of bonding tool 200 including inner chamfer 200c and face portion 200d. As will be explained in greater detail below, bonding tool 200 is an example of a bonding tool which may be provided with an improved surface in accordance with the present invention.

Of course, bonding tools 100 and 200 are only examples of the types of bonding tools which may be provided with an improved surface in accordance with the present invention. Any of a number of other types of bonding tools may also utilize the benefits of the present invention.

As is known to those skilled in the art, it is generally desired to polish bonding tools. In certain bonding tools, a “matte” finish is provided to the surface of the bonding tool. In contrast to conventional polished and matte finish bonding tools, according to the present invention, bonding tools are provided wherein a grain structure of the material of the bonding tool (e.g., a ceramic material, etc.) is exposed for at least a portion of the bonding tool (e.g., a portion of the tip portion of the bonding tool). Further, in certain exemplary embodiments of the present invention, the surface of at least a portion of the bonding tool (e.g., a tip portion of the bonding tool) defines a plurality of asperities, wherein a density of the asperities is at least 15 micronŝ−2, and wherein a surface roughness average at the portion of the tip portion defining the plurality of asperities is at least 0.03 microns.

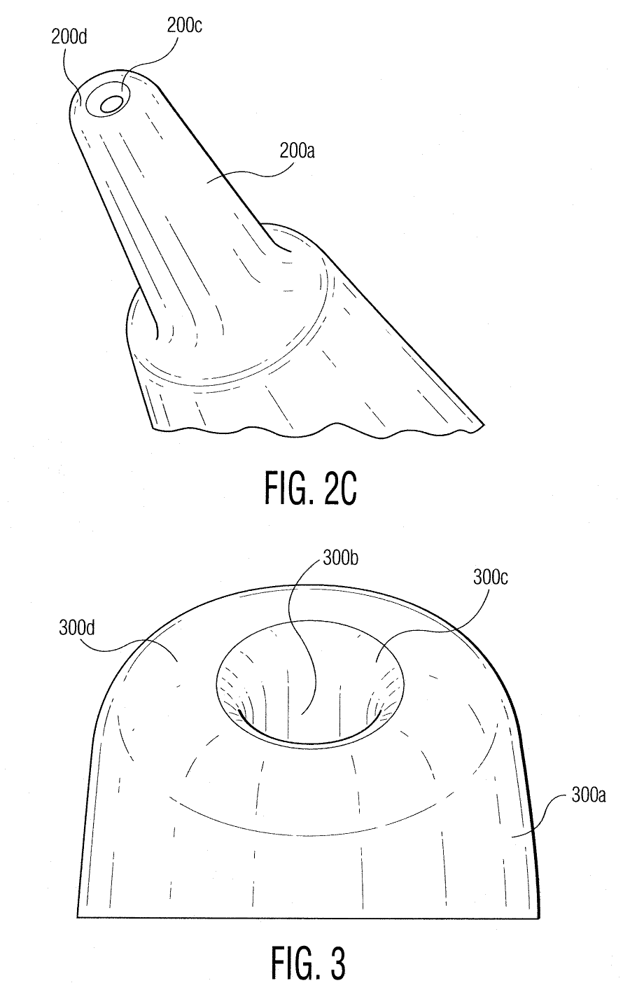

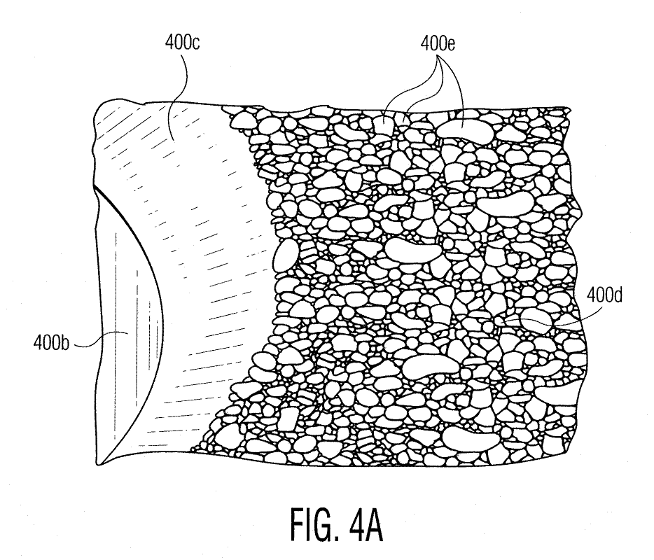

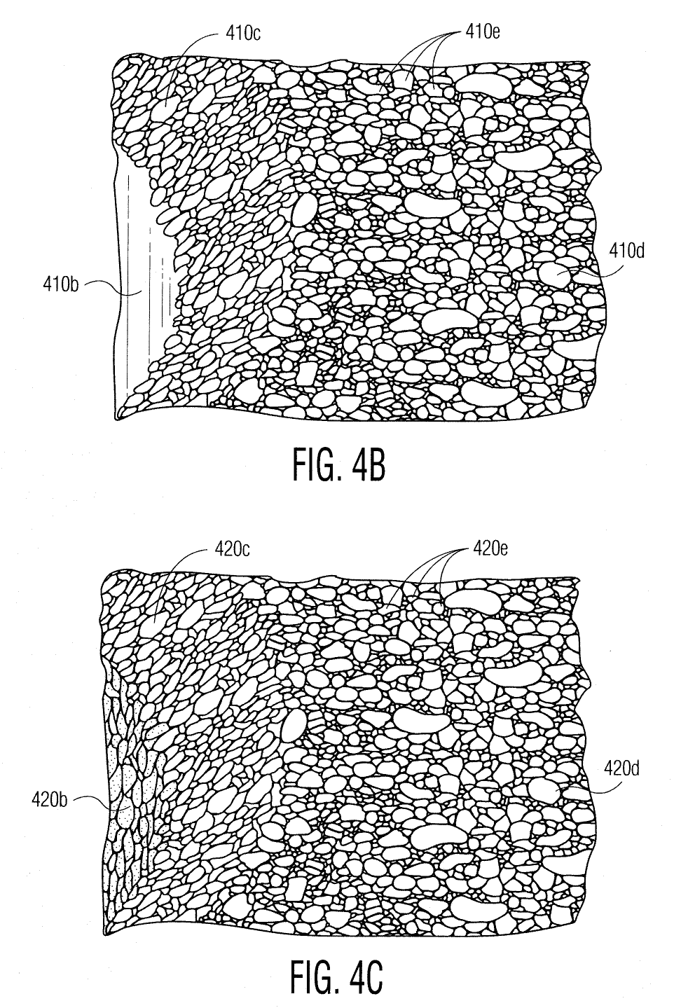

FIG. 3 is a perspective view of tip portion 300a (similar to tip portions 100a and 200a shown in FIGS. 1B, 2B, and 2C) of a bonding tool in accordance with an exemplary embodiment of the present invention. Tip portion 300a defines hole 300b, inner chamfer 300c, and face portion 300d. FIGS. 4A-4C are detailed views of a portion of a tip portion of a bonding tool similar to tip portion 300a shown in FIG. 3; however, each of FIGS. 4A-4C illustrate a different surface morphology of the respective tip portion.

More specifically, FIG. 4A is a close up view of a portion of a tip portion of a bonding tool (analogous to tip portion 300a shown in FIG. 3). Thus, in FIG. 4A, a portion of (1) hole 400b (which is analogous to hole 300b in FIG. 3); (2) inner chamfer 400c (which is analogous to inner chamfer 300c in FIG. 3); and (3) face portion 400d (which is analogous to face portion 300d in FIG. 3) are shown. As is clear in FIG. 4A, the material of the surface of working face 400d has an exposed grain structure (in the illustrated example, the exposed grains may be terms asperities 400e). In contrast, the material of the surface of hole 400b (i.e., the wall portion of the bonding tool that defines hole 400b) and inner chamfer 400c does not include exposed grains. For example, the surface of hole 400b and inner chamfer 400c may be a conventional polished or matte finish surface.

Referring now to FIG. 4B, a portion of (1) hole 410b (which is analogous to hole 300b in FIG. 3); (2) inner chamfer 410c (which is analogous to inner chamfer 300c in FIG. 3); and (3) face portion 410d (which is analogous to face portion 300d in FIG. 3) are shown. As is clear in FIG. 4B, the material of the surfaces of working face 410d and of inner chamfer 410c have exposed grains (in the illustrated example, the exposed grains may be terms asperities 410e). In contrast, in FIG. 4B, the material of the surface of hole 410b (i.e., the wall portion of the bonding tool that defines hole 410b) does not include exposed grains. For example, the surface of hole 410b may be a conventional polished or matte finish surface.

Referring now to FIG. 4C, a portion of (1) hole 420b (which is analogous to hole 300b in FIG. 3); (2) inner chamfer 420c (which is analogous to inner chamfer 300c in FIG. 3); and (3) face portion 420d (which is analogous to face portion 300d in FIG. 3) are shown. As is clear in FIG. 4C, the material of the surfaces of working face 420d, inner chamfer 420c, and of hole 420b have exposed grains. In the illustrated example, the exposed grains may be terms asperities 420e.

From reviewing FIGS. 4A-4C, it is clear that any combination of portions of a tip portion of a bonding tool (and in fact any portion of the bonding tool) may have surface finishes in accordance with the present invention, while other surfaces may have different (e.g., conventional) finishes.

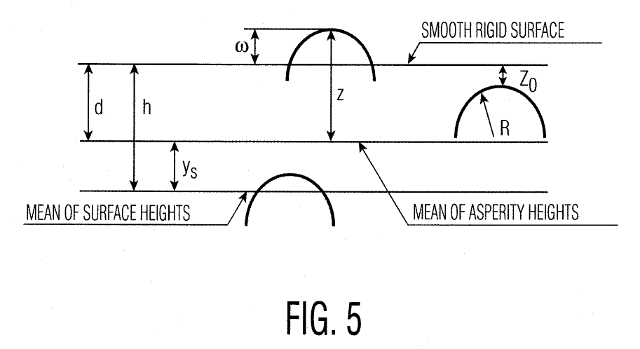

FIG. 5 is a diagram of a contact model of rough surfaces useful for understanding exemplary bonding tool surfaces in accordance with the present invention. In fact, FIG. 5 of the present application is very similar to FIG. 2 provided in the article cited above entitled “A Static Friction Model for Elastic-Plastic Contacting Rough Surfaces” which was authored by Lior Kogut and Izhak Etsion, and published in the Journal of Tribology (ASME), Vol. 126, pp. 34-40, January 2004. This figure, as well as the remainder of this article, are useful in understanding certain terminology used herein in connection with rough surfaces.

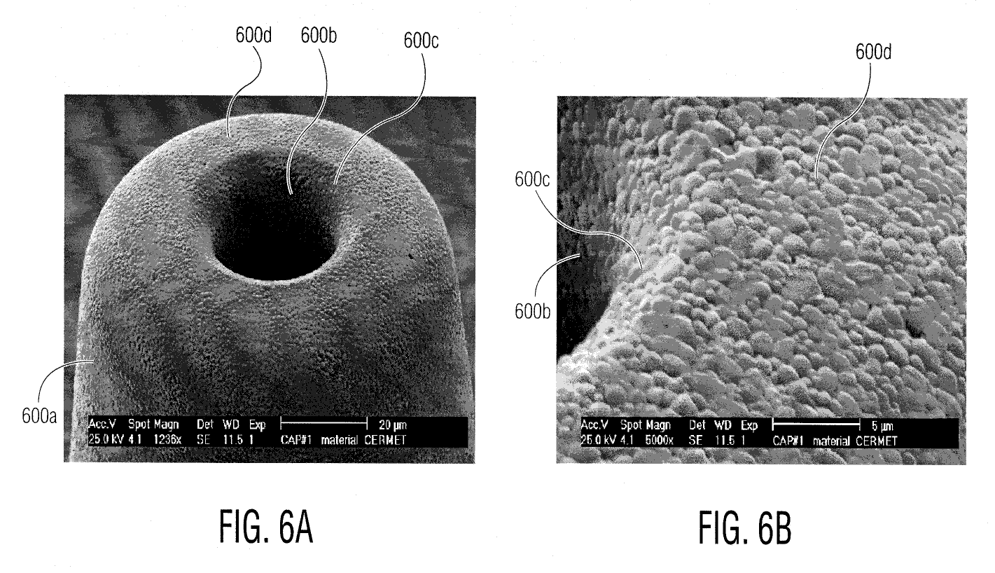

FIG. 6A is a perspective view photograph of tip portion 600a of a bonding tool (e.g., a capillary tool) with a coarse surface morphology in accordance with the present invention. For example, this surface morphology is provided in order to improve the wire bonding performance. Tip portion 600a include hole 600b (i.e., the wall portion of the bonding tool that defines hole 600b), inner chamfer 600c, and face portion 600d. FIG. 6B is a detailed view of a portion of FIG. 6A which clearly illustrates the granular asperities on the surface of tip portion 600a. As is illustrated in FIGS. 6A-6B, each of hole 600b, inner chamfer 600c, and face portion 600d (as well as other areas of tip portion 600a including the outer radius of the tip portion) include the surface morphology defined by an exposed grain structure of the material of the tip portion (and also characterized by a high density of asperities). Using this innovative bonding tool surface morphology (compared to conventional polished and conventional matte finish surface morphology) an improved wire bonding process may be provided, for example, in terms of stitch pull variability (e.g., standard deviation) and process robustness.

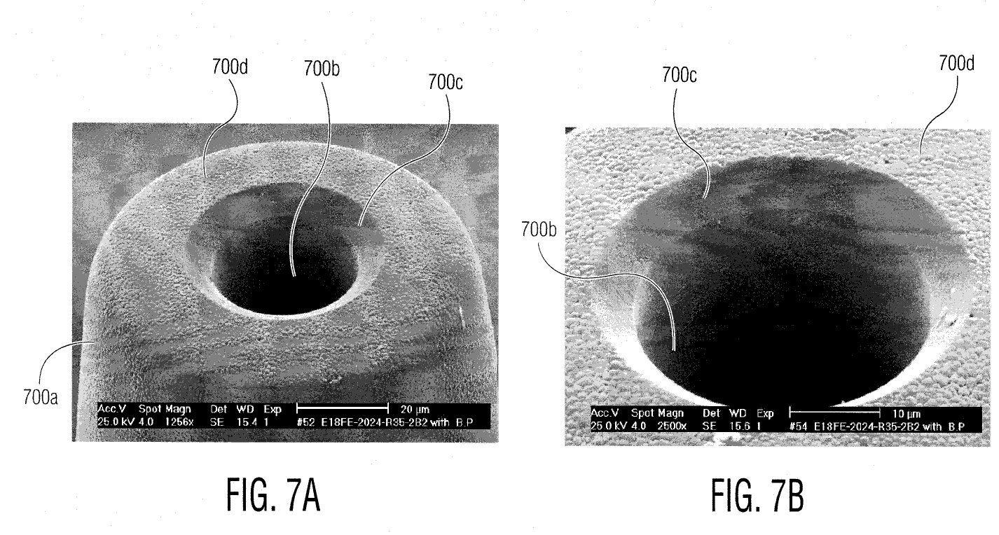

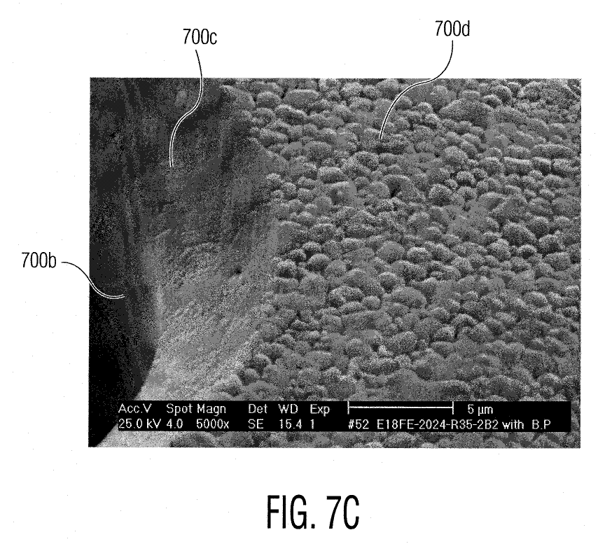

FIG. 7A is a perspective view photograph of tip portion 700a of another bonding tool (e.g., a capillary tool) with a coarse surface morphology in accordance with the present invention. Tip portion 700a include hole 700b (i.e., the wall portion of the bonding tool that defines hole 700b), inner chamfer 700c, and face portion 700d. FIGS. 7B-7C are detailed views of portion of FIG. 7A which clearly illustrates the granular asperities on a portion of the surface of tip portion 700a. As is illustrated in FIGS. 7A-7C, face portion 700d (as well as the exterior area of tip portion 700a including the outer radius of the tip portion) include the surface morphology defined by an exposed grain structure of the material of the tip portion (and also characterized by a high density of asperities); however, hole 700b and inner chamfer 700c do not include this surface morphology. For example, the surface of hole 700b and inner chamfer 700c may include a conventional surface (e.g., a polished or matte finish surface, amongst others).

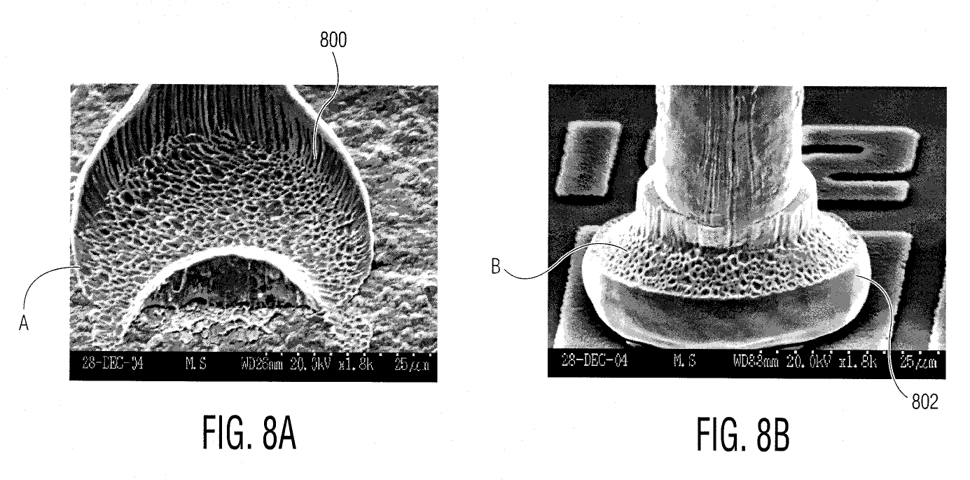

FIG. 8A is a photograph of second bond 800 of a wire loop formed using a bonding tool in accordance with an exemplary embodiment of the present invention. As is clear from FIG. 8A, region “A” of second bond 800 is characterized by the asperity shapes of a bonding tool with a surface finish according to the present invention on the face portion of the bonding tool. FIG. 8B is a photograph of first bond 802 of a wire loop formed using a bonding tool in accordance with an exemplary embodiment of the present invention. As is clear from FIG. 8B, region “B” of first bond 802 is characterized by the asperity shapes of a bonding tool with a surface finish according to the present invention on the inner chamfer of the bonding tool.

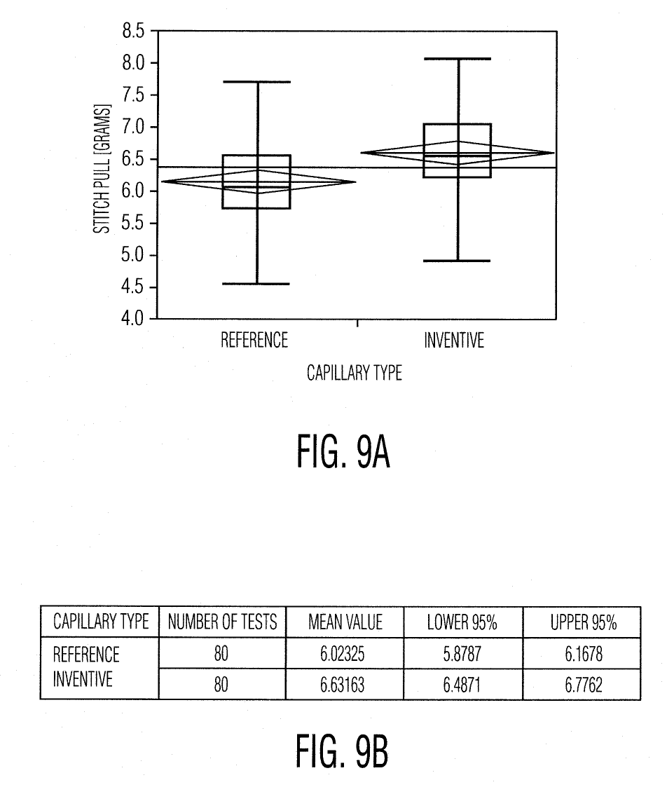

FIG. 9A is a graphical representation of data tabulated in FIG. 9B comparing stitch pull test results for a reference capillary tool and a capillary tool in accordance with an exemplary embodiment of the present invention (i.e., the graph compares stitch pull test results for stitch bonds of wire loops formed using a reference capillary tool and an inventive capillary tool). The diamond shapes in FIG. 9A refer to the stitch pull standard deviation. The rectangular shapes refer to the stitch pull median values. The horizontal line bisecting the rectangular shapes refers to the average stitch pull value (i.e., the horizontal line for the reference capillary is 6.02325 as shown in FIG. 9B, and the horizontal line for the inventive capillary is 6.63163 as shown in FIG. 9B). As shown in FIGS. 9A-9B, the capillary according to the present invention has higher and more consistent stitch pull values at second bond. For example, FIG. 9B indicates that of the 80 samples taken, 95% of the stitch pull values were between 5.8787 and 6.1678 grams for a reference capillary, whereas 95% of the stitch pull values were between 6.4871 and 6.7762 grams for a capillary according to an exemplary embodiment of the present invention.

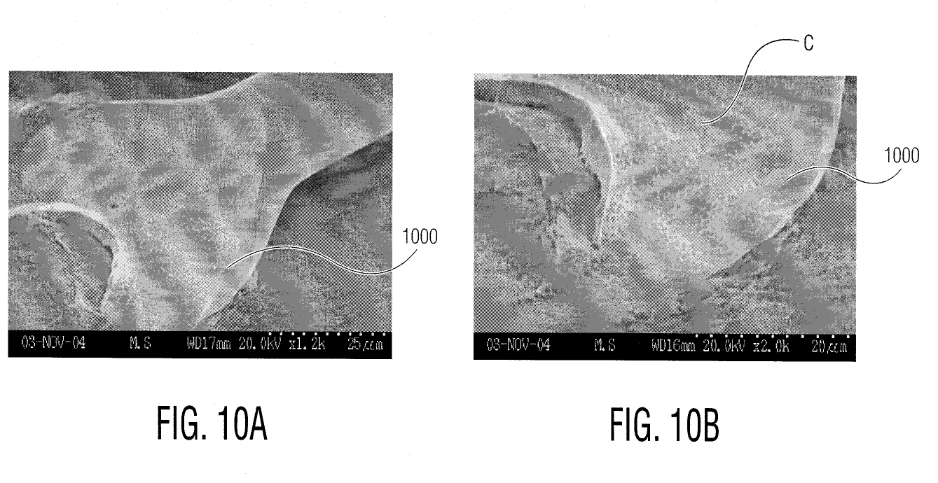

FIG. 10A is a photograph of second bond 1000 (i.e., a stitch bond) of a wire loop formed in accordance with an exemplary embodiment of the present invention. FIG. 10B is a detailed view of a portion of second bond 1000, where region “C” makes clear that second bond 1000 was formed using a bonding tool having a face portion in accordance with the present invention. The inventors have determined that the gripping between (1) the face portion of the bonding tool according to the present invention and (2) the stitch bond of a wire loop provides for increased stitch pull values.

As is known to those skilled in the art, by definition, the Cpk is:

$$Cpk = min \{ \begin{matrix}( U - \overline{X} ) / 3 S \\ ( \overline{X} - L ) / 3 S\end{matrix} \qquad ( 1 )$$

where Cpk—Process capability; U—Upper tolerance limit; L—Lower tolerance limit; X—Average process response (e.g., average stitch pull value); and S—Standard deviation process response (e.g., stitch pull stdev).

Cpk is a dimensionless measurement which is used in connection with various process parameters, and is related to the standard deviation of the parameter. For example, Cpk may be used in connection with the stitch pull parameter value. By analyzing equation (1) above, it is clear that a high Cpk value indicates high stitch bond value repeatability in comparison to a low Cpk value.

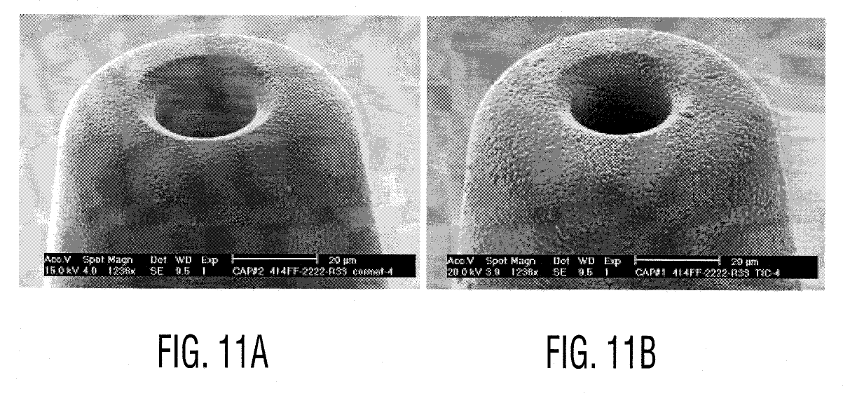

FIGS. 11A-11B are photographs of two tip portions of two bonding tools. FIG. 11A illustrates morphology A, while FIG. 11B illustrates morphology B. Each of morphology A and morphology B has (1) a density of the asperities that is at least 15 micronŝ−2, and (2) an average surface roughness of at least 0.03 microns. While both morphologies A and B have (1) a higher average surface roughness, and (2) a higher density of asperities in comparison to conventional bonding tools, morphology B has a higher average surface roughness and a higher density of asperities in comparison to morphology A. Both bonding tool groups (i.e., morphology A and morphology B) provided significantly improved stitch pull Cpk values compared to the reference group (which was polished surface capillaries). For example, the improved stitch pull values are beneficial for various applications including, for example, fine pitch, ultra fine pitch, and QFP applications, with any type of wire including both Cu and Au wires.

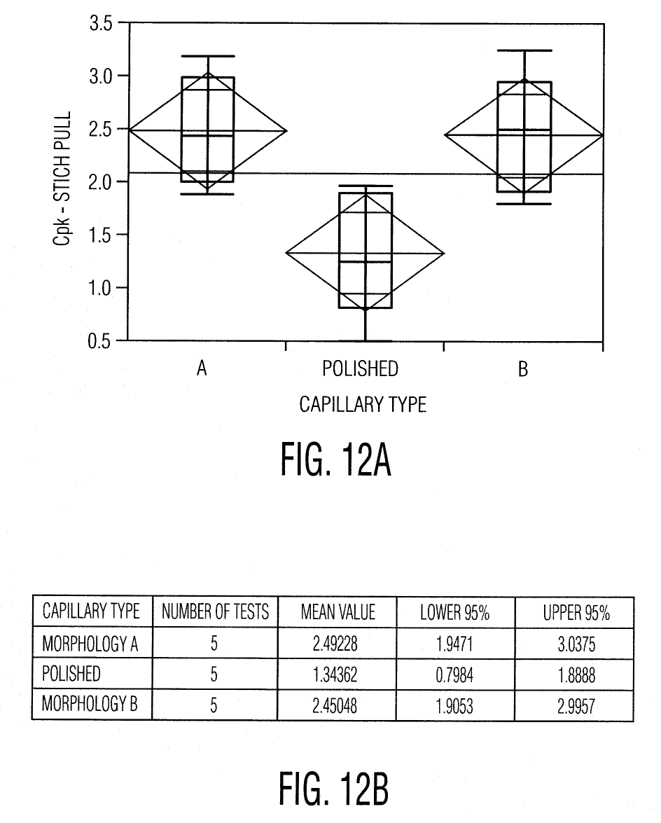

FIGS. 12A-12B illustrate a graph (FIG. 12A) and supporting data (FIG. 12B) which indicate Cpk values for morphology A and B, as well as for a polished reference bonding tool. As is clear from FIGS. 12A-12B, bonding tools according to the present invention have higher and more consistent stitch pull Cpk values than conventional polished bonding tools. The diamond shapes in FIG. 12A refer to the stitch pull Cpk standard deviation. The rectangular shapes refer to the stitch pull Cpk median values. The horizontal line bisecting the rectangular shapes refers to the average stitch pull Cpk value (i.e., the horizontal line for the morphology A is 2.49228 as shown in FIG. 12B, the horizontal line for the conventional polished capillary is 1.34362 as shown in FIG. 12B, and the horizontal line for the morphology B is 2.45048 as shown in FIG. 12B). As shown by comparing the results of FIGS. 12A-12B, it is clear that the bonding tools according to the present invention have higher and more consistent stitch pull Cpk values.

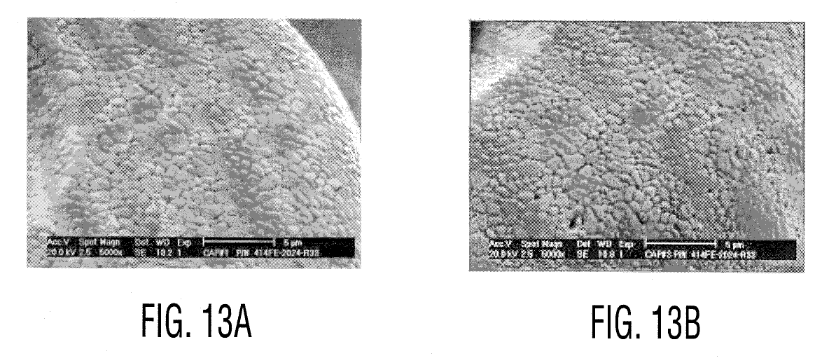

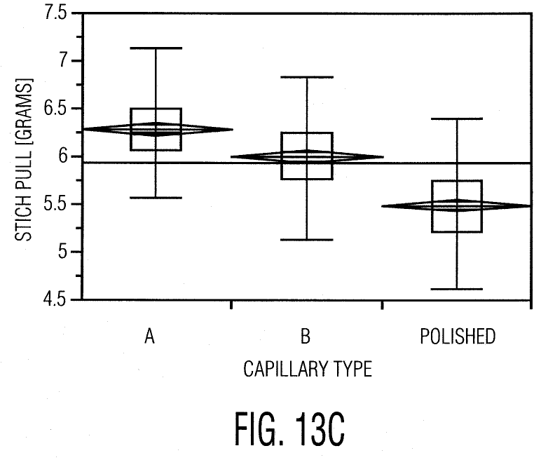

FIGS. 13A-13B are photographs of a portion of a tip portion of a bonding tool having morphology A (FIG. 13A) and morphology B (FIG. 13B). FIG. 13C compares stitch pull values for morphology A (left portion of graph), morphology B (center portion of graph), and for a conventional polished capillary (right portion of graph). As is clear from FIG. 7C, the higher the surface roughness and the density of asperities, the higher the stitch pull value.

Experiments conducted by the inventors have shown that the bonding tools with tip portions having surfaces according to the present invention have (1) a longer life, and (2) a longer MTBA (mean time between assists) in comparison to conventional matte or polished finish tools. More specifically, the finish of the bonding tool of the present invention tends to resist formation and/or adherence of undesirable material which reduces the life of the tool, and/or requires an assist. Experimental data has shown 0.27 assists per hour for a tool according to the present invention, in comparison to 0.62 assist per hour for a conventional matte finish tool, and 2 assists per hour for a conventional polished tool. Further, the overall assist rate improvement was 77.3 in comparison to conventional matte finish tools, and 47.6% for conventional polished finish tools.

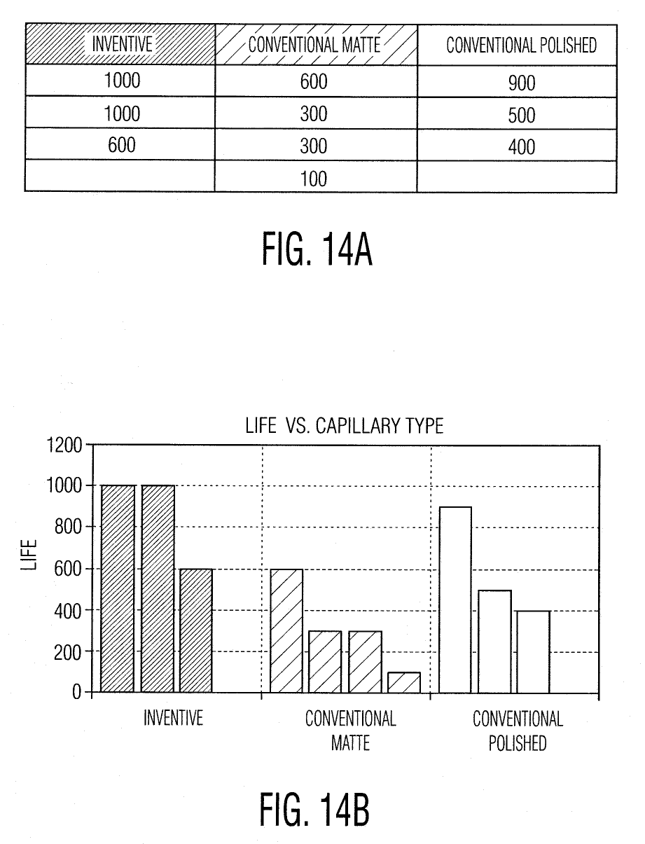

Regarding the extended life of bonding tools formed according to the present invention, FIGS. 14A-14B are provided. FIG. 8A is a table with life test results for various capillary bonding tools. The left hand column tabulates results for three capillaries according to the present invention; the center column (conventional matte) tabulates results for four conventional matte finish capillaries; and the right column (conventional polished) tabulates results for three conventional polished finish capillaries. The maximum number of results for the experiment is 1 million, and if the tool reached 1 million bonds, the experiment was terminated. The left hand column had life results of 1000; 1000; and 600 (in thousands of operations or KBonds, thus equivalent to 1 million, 1 million, and 600,000 operations). The center column had life results of 600; 300; 300; and 100. The right hand column had life results of 900; 500; and 400. Thus, the left hand column illustrates an extended life for capillaries according to the present invention. FIG. 8B is a bar chart of the results of FIG. 8A.

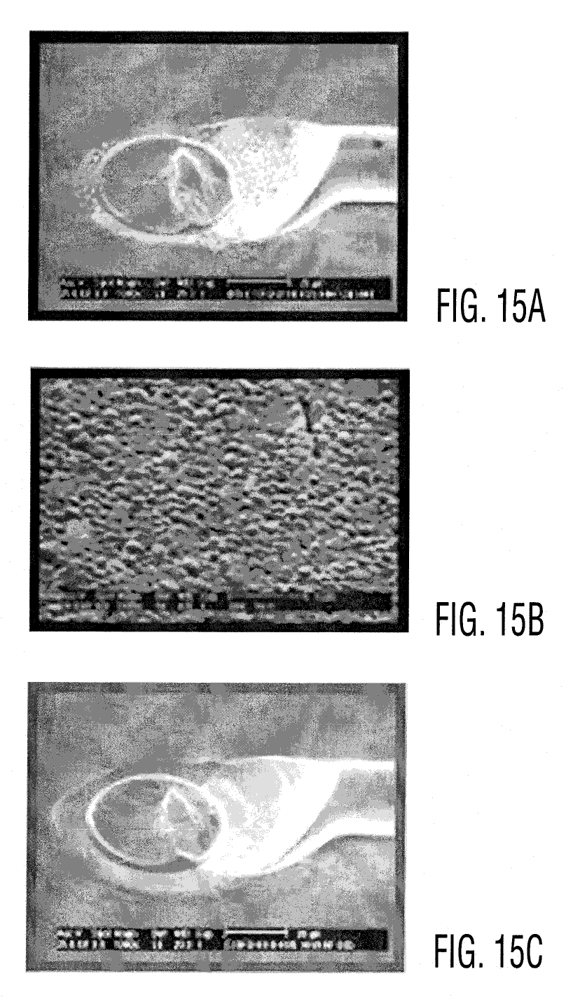

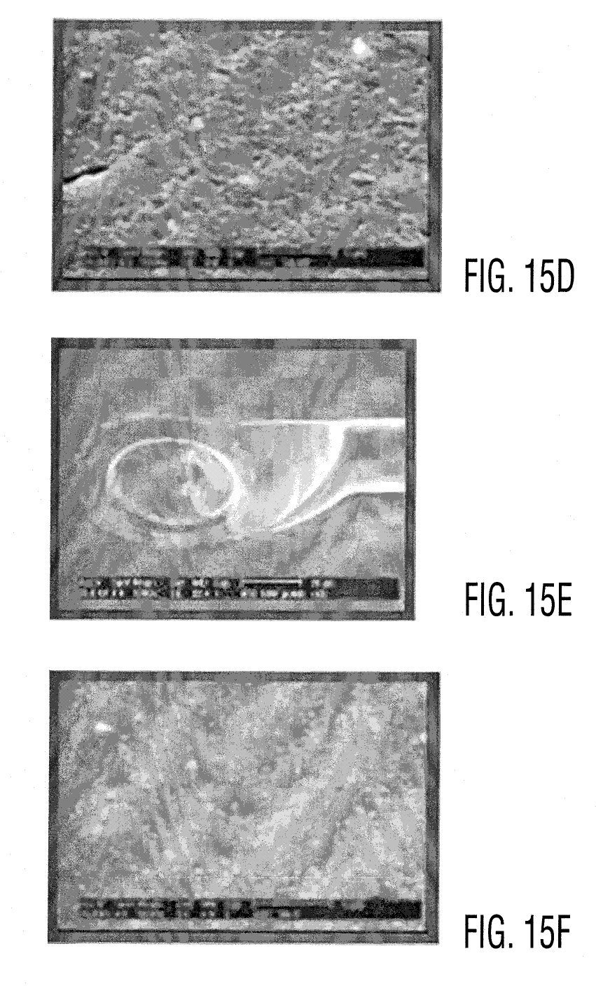

FIGS. 15A-15F are a series of photographs of second bonds of a wire loop, along with the finish of the bonding tool used to form the respective second bond. More specifically, FIG. 15A illustrates a second bond formed with a tool according to an exemplary embodiment of the present invention, and FIG. 15B is a photograph of a portion of the tip surface of the bonding tool used to form the second bond illustrated in FIG. 15A. Likewise, FIG. 15C illustrates a second bond formed with a conventional matte finish, and FIG. 15D is a photograph of a portion of the tip surface of the bonding tool used to form the second bond illustrated in FIG. 15C. Likewise, FIG. 15E illustrates a second bond formed with a conventional polished finish, and FIG. 15F is a photograph of a portion of the tip surface of the bonding tool used to form the second bond illustrated in FIG. 15E.

In copper bonding, experimentation was done testing identical geometric designs for a bonding tool having (1) a tip surface finish according to the present invention, and (2) a conventional polished finish. Only the tool having a tip surface finish according to the present invention enabled a valid wire bonding process with copper because of the overwhelming reduction in assists in comparison to the polished tool. The tests were done for copper wire bonding when forming bonds in both the x-axis direction and the y-axis direction (as is understood by those skilled in the art, depending upon the device being wirebonded and the wire bonding machine, wire bonds are often formed in numerous directions).

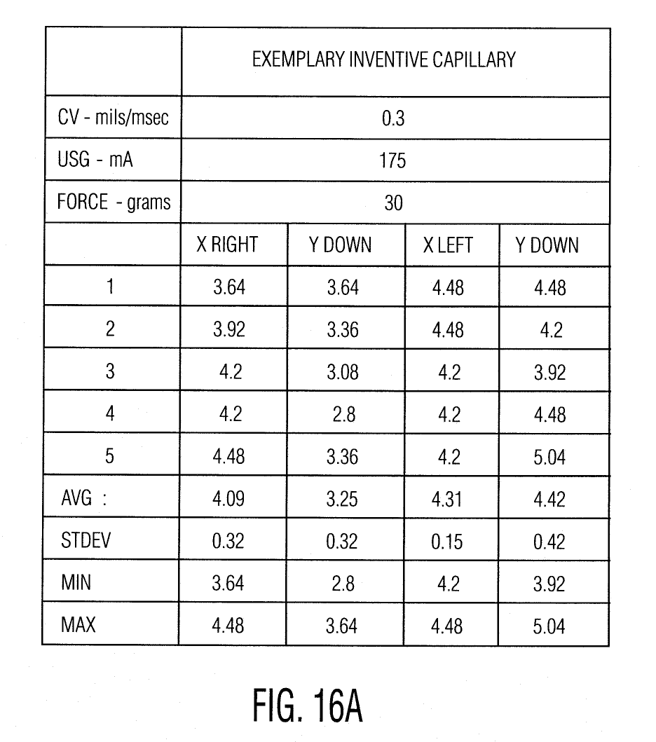

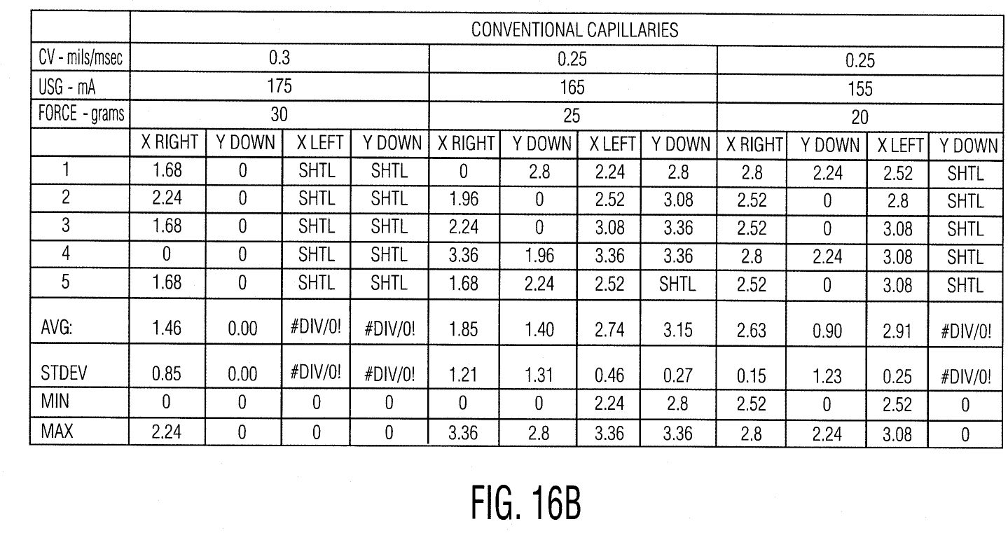

FIGS. 16A-16B are tables illustrating the benefits of the present invention in terms of second bond pull strength in copper bonding. More specifically, FIG. 16A illustrates data for a bonding tool with a tip surface according to an exemplary embodiment of the present invention. As is seen by reviewing the results in FIG. 16A, the bonding tool according to the present invention illustrated high and consistent pull strengths for bonds formed in any direction (i.e., the x right direction, the y down direction, the x left direction, and the y down direction). In contrast, FIG. 16B illustrates low and inconsistent pull strengths for the bonds. In fact, many of the bonds pull-tested in FIG. 16B provided no measurable pull strength (e.g., short-tail (SHTL), # DIV/0!, etc.).

Thus, the bonding tool of the present invention yields higher and more consistent values of tail strength (i.e., 2^{nd} bond pull strength), where a conventional polished capillary yielded poor and inconsistent results such as short tail—premature wire break when the capillary is rising to tail height position. Further, the process parameters range (window) for the polished capillary represent the difficulties to find in the challenging Cu bonding application, a parameters window that enable an uninterruptible automatic wire-bonding process.

The present invention is not limited to any specific method of forming the claimed surface. As is understood by those skilled in the art, bonding tools (e.g., capillary tools, wedge tools, etc) are formed from a wide range of materials, and the methods used to form a surface according to the present invention will vary greatly depending upon the materials used and the finish desired.

One exemplary method of exposing the grain structure of the material at the desired portion of the bonding tool is through thermal etching consistent with the material being etched. Other exemplary methods of forming the desired surface may include, for example: (1) forming a green body from the desired material (e.g., a ceramic material), grinding the green body to the desired external shape (taking into account the shrinkage that will occur), sintering the tool to get the desired tip surface (e.g., granular surface), and forming/polishing the desired dimension of hole and the inner chamfer; (2) the same as (1), except that the desired tip surface (e.g., a granular surface) may be kept on the hole and the inner chamfer; (3) same as (1) or (2), except that sintering aids may be added to the material when forming the green body in order to control grain size and shape; (4) sintering a green body, grinding the sintered green body to the desired final external dimension, thermal etching at an elevated temperature to get the granular tip surface, and forming/polishing the desired dimension of hole and inner chamfer; (5) the same as (4) except that the desired tip surface (e.g., a granular surface) may be kept on the hole and the inner chamfer; (6) forming a green body from the desired material (e.g., a ceramic material), firing the green body, grinding to the desired dimension (taking into account the shrinkage that will occur after firing process); and (7) depending upon the material selected, exposing the tool (e.g., a tool that has been grinded to the desired shape) to an elevated temperature profile in a controlled environment.

Of course, these exemplary methods may vary, and steps may be deleted or added, and the order of the steps may the changed. For example, the desired surface may be formed on the desired portion of the bonding tool, and then part of the bonding tool may be polished to remove the formed surface from that region. Again, there are many ways in which to form the claimed surfaces, and the present invention is not dependent on any specific process.

By providing a bonding tool according to the present invention, a number of improvements in the performance and reliability of a wire bonding process may be achieved, for example: (1) a decreased stitch pull variability (standard deviation); (2) improved process robustness (e.g., increased MTBA by overcoming difficulties such as NSOP, SHTL, NSOL EFO); (3) increased average 2^{nd} bond process stitch pulls values; (4) increased looping performance (standard deviation); (5) decreased 1^{st} bond diameter variability and shape (standard deviation); and (6) increased overall wire bonding durability.

Bonding tools according to the present invention may provide additional benefits when used for bonding wires to certain types of contacts (e.g., contacts plated with materials such as NiPd). Such contacts (with materials having a relatively high hardness value) can shorten the life of the bonding tool (e.g., through problems such as bonding tool tip wear out, tip contamination, etc.), particularly through bonding operations (e.g., ultrasonic vibrations) at second bond of a wire loop. According to the present invention, the life span of the capillary can be significantly improved. In fact, tests conducted on a wire bonding machine sold by Kulicke and Soffa Industries, Inc. (i.e., a K&S 8028 PPS ball bonder machine using a 60 micron Bond Pad Pitch NiPd device, with a K&S 1.0 mil AW14 wire) revealed life spans of approximately twice a conventional bonding tool. Using bonding tools according to the present invention, and using the same type of wire bonding machine (when bonding a 50 micron BPP NiPd device, with a K&S 0.8 mil AW-66 wire), significantly improved second bond stitch pull and Cpk values were provided. One reason for the improved second bond stitch values using a bonding tool according to the present invention is related to the coarse tip surface. The coarse tip surface tends to improve: (1) gripping between the bonding tool tip and the wire, (2) the energy transition (e.g., the ultrasonic energy transition) through the bonding tool to the wire; and (3) the energy transition through the bonding tool to the second bond contact (e.g., leads of a leadframe).

Although the present invention has been described primarily in terms of a tip portion of a bonding tool having a desired morphology, it is not limited thereto. For example, the entire bonding tool (both interior and exterior) may have the desired morphology (e.g., it may be desired that the portion of the body portion configured to be engaged in a transducer of a wire bonding machine have the desired morphology because it provides improved contact/coupling therebetween). Alternatively, only a selected portion of the bonding tool (e.g., the outside of the bonding tool but not the wire path inside the tool) may have the desired morphology. As provided herein, even with respect to the tip portion of the bonding tool, either all or a selected portion of the tip portion may have the desired morphology.

Although the present invention has been illustrated and described primarily with respect to capillary tools used in a ball bonding operation it is not limited thereto. Other types of bonding tools (e.g., wedge tools, ball shooter tools, etc) are also within the scope of the invention. Further, the present invention may be applied to other types of tools used in semiconductor processing such as pick up tools, SMT tools (surface mount technology tools), ribbon tools, etc). Further still, the present invention may be applied to tools (1) formed from a unitary piece of material such as a ceramic material, or (2) formed from a plurality of pieces.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A bonding tool comprising a body portion terminating at a tip portion, the tip portion being formed from a material, wherein a grain structure of the material is exposed for at least a portion of the tip portion.

2. The bonding tool of claim 1 wherein the grain structure of a face portion of the tip portion is exposed.

3. The bonding tool of claim 1 wherein the grain structure of an inner chamfer of the tip portion is exposed.

4. The bonding tool of claim 1 wherein the body portion includes an engagement portion configured for engagement with a transducer of a wire bonding machine, the grain structure of the engagement portion being exposed.

5. The bonding tool of claim 1 wherein the bonding tool is formed as a unitary piece of the material, and wherein the grain structure of the material is exposed at the entire exterior of the bonding tool.

6. The bonding tool of claim 1 wherein a surface of the portion of the tip portion with an exposed grain structure defines a plurality of asperities, wherein a density of the asperities is at least 15 micronŝ−2, and wherein a surface roughness average at the portion of the tip portion defining the plurality of asperities is at least 0.03 microns.

7. The bonding tool of claim 6 wherein the density of asperities is at least 20 micronŝ−2.

8. The bonding tool of claim 6 wherein the density of asperities is at least 20 micronŝ−2, and wherein the surface roughness average is at least 0.04 microns.

9. The bonding tool of claim 1 wherein the bonding tool defines a hole extending along the length of the bonding tool wherein the hole is configured to receive a length of wire, the hole terminating at an inner chamfer of the tip portion, the tip portion defining a face portion at a terminal end of the tip portion adjacent the inner chamfer, and wherein the grain structure of at least one of (1) the inner chamfer and (2) the face portion is exposed.

10. The bonding tool of claim 9 wherein the grain structure of both the inner chamfer and the face portion is exposed.

11. The bonding tool of claim 9 wherein the grain structure of the face portion is exposed, and wherein the grain structure of the surface of the inner chamfer is not exposed.

12. The bonding tool of claim 11 wherein the surface of the inner chamfer is polished.

13. A bonding tool comprising a body portion terminating at a tip portion wherein a surface of at least a portion of the tip portion defines a plurality of asperities, wherein a density of the asperities is at least 15 micronŝ−2, and wherein a surface roughness average at the portion of the tip portion defining the plurality of asperities is at least 0.03 microns.

14. The bonding tool of claim 13 wherein the density of asperities is at least 20 micronŝ−2.

15. The bonding tool of claim 13 wherein the density of asperities is at least 20 micronŝ−2, and wherein the surface roughness average is at least 0.04 microns.

16. The bonding tool of claim 13 wherein the bonding tool defines a hole extending along the length of the bonding tool wherein the hole is configured to receive a length of wire, the hole terminating at an inner chamfer of the tip portion, the tip portion defining a face portion at a terminal end of the tip portion adjacent the inner chamfer, and wherein a surface of at least one of (1) the inner chamfer and (2) the face portion defines the plurality of asperities wherein a density of the asperities is at least micronŝ−2, and wherein a surface roughness average at the at least one of (1) the inner chamfer and (2) the face portion is at least 0.03 microns.

17. The bonding tool of claim 16 wherein the density of asperities is at least 20 micronŝ−2.

18. The bonding tool of claim 16 wherein the density of asperities is at least 20 micronŝ−2, and wherein the surface roughness average is at least 0.04 microns.

19. The bonding tool of claim 16 wherein the surface of both the inner chamfer and the face portion defines the plurality of asperities.

20. The bonding tool of claim 16 wherein the surface of the face portion defines the plurality of asperities, and wherein the surface of the inner chamfer is polished.

21. The bonding tool of claim 13 wherein the body portion includes an engagement portion configured for engagement with a transducer of a wire bonding machine, wherein a surface of the engagement portion also defines the plurality of asperities wherein a density of the asperities is at least 15 micronŝ−2, and wherein a surface roughness average at the surface of the engagement portion is at least 0.03 microns.

22. The bonding tool of claim 13 wherein the bonding tool is formed as a unitary piece of the material, and wherein a surface of the entire exterior of the bonding tool defines the plurality of asperities wherein a density of the asperities is at least 15 micronŝ−2, and wherein a surface roughness average at the surface of the entire exterior of the bonding tool is at least 0.03 microns.
